(19) United States
(12) Patent Application Publication
(10) Pub. No.: US 2004/0258393 A1
(43) Pub. Date: Dec. 23, 2004

(54) Trick modes using non-progressive dummy predictive pictures

(76) Inventors: Shu Lin, Indianapolis, IN (US); Donald Henry Willis, Indianapolis, IN (US)

Correspondence Address: Joseph S Tripoli, Thomson Multimedia Licensing Inc, P O Box 5312, Princeton, NJ, 08543-5312, US

(21) Appl. No.: 10/493,347

(22) PCT Filed: Oct. 22, 2002
(86) PCT No.: PCT/US02/33826

Related U.S. Application Data
(60) Provisional application No. 60/334,914, filed on Oct. 23, 2001.

(51) Int. Cl. H04N 5/783

(52) U.S. Cl. 386/68; 386/125

(57) ABSTRACT

The invention concerns a method and system for performing a trick mode on a video signal containing a plurality of original pictures. The method includes the steps of receiving a trick mode command and selectively inserting at least one dummy predictive picture in the trick mode video signal using at least one prediction scheme among field-based prediction and frame-based prediction. In one arrangement, the selectively inserting step can include the step of selectively inserting at least a first dummy predictive picture in the video signal using field-based prediction and subsequent dummy predictive pictures in the trick mode video signal using frame-based prediction.

### CROSS REFERENCE TO RELATED APPLICATIONS

This application claims priority under 35 U.S.C. 119(e) to Provisional Application Ser. Number 60/334,914 filed on Oct. 23, 2001.

### STATEMENT REGARDING FEDERALLY SPONSORED RESEARCH OR DEVELOPMENT

(Not Applicable)

### BACKGROUND OF THE INVENTION

1. Technical Field

The inventive arrangements relate generally to video systems and more particularly to video systems that record or play back digitally encoded video sequences.

2. Description of Related Art

Digital televisions (DTV) and high-definition televisions (HDTV) are gaining popularity in today's consumer electronics marketplace. Many purchasers of these types of televisions also buy digital video recorders or players, such as digital video disc (DVD) recorders or players, for purposes of viewing previously recorded programs or recording their favorite programs. Notably, the combination of a DTV (or an HDTV) and a digital video recorder or player can be an integral part of a home theater entertainment system.

A digital video recorder or player typically contains a Moving Pictures Expert Group (MPEG) decoder to decode the digitally encoded multimedia data that is stored on the discs that the recorder or player plays. If the digital video recorder or player is connected to a conventional (non-DTV or non-HDTV) television, the digitally encoded signal will be decoded by the digital video recorder or player's MPEG decoder before being displayed on the conventional television. Significantly, however, many DTV's contain their own MPEG decoders. As such, if a digital video recorder or player is connected to a DTV, the video signal read from the disc is remotely decoded by the DTV's decoder. This configuration can be referred to as a remote decoder arrangement.

There is, however, an important disadvantage to decoding digitally encoded signals with a remote DTV decoder. Namely, it is very difficult to perform trick modes in this type of arrangement. A trick mode can be any playback of video in which the playback is not done at normal speed or in a forward direction. Oftentimes, a trick mode involves repeating a number of pictures in a video signal such as during a slow motion or freeze trick mode. As the bandwidth between the digital video recorder or player and the DTV is limited, repeating pictures in the signal being fed to the DTV may cause the signal to exceed the maximum bit rate limit of the transmission channel. The problem is even more acute if the pictures are intra (I) pictures or predictive (P) pictures, as these pictures may be encoded with a relatively large number of bits.

In addition to the bit rate problem, there is another disadvantage to decoding video signals remotely: the repeated display of non-progressive pictures in such an arrangement can cause a vibration effect to appear in the display if the repeated pictures contain a moving object. To explain this drawback, a brief explanation of interlaced scanning is warranted.

Many televisions employ the interlaced scanning technique. Under this format, the video signal is typically divided into a predetermined number of horizontal lines. During each field period, only one-half of these lines are scanned; generally, the odd-numbered lines are scanned during the first field period, and the even-numbered lines are scanned during the next field period. Each sweep is referred to as a field, and when combined, the two fields form a complete picture or frame. For an NTSC system, sixty fields are displayed per second, resulting in a rate of thirty frames per second.

As a moving object moves across the screen in an interlaced scanning television, each field will only display a portion of the moving object. This partial display is because a field only displays every other horizontal line of the overall picture. For example, for a particular field n, only the odd-numbered horizontal lines are scanned, and the portion of the moving object that will be displayed in field n is the portion that is scanned during the odd-numbered horizontal line sweep for field n. The next field, field n+1, is created 1/60 of a second later and will display the even-numbered horizontal lines of the picture. Thus, the portion of the moving object that is displayed in field n+1 is the portion that is scanned during the even-numbered horizontal line sweep for field n+1. Although each field is temporally distinct, the human eye perceives the sequential display of the fields as smooth motion due to the speed at which the fields are displayed. I If a viewer activates a trick mode, the trick mode video signal may contain repeated pictures, pictures that were recorded under the interlaced scanning format. For example, if the viewer initiates a freeze trick mode on a particular picture, then that picture can be repeatedly transmitted to and decoded and displayed at the DTV containing the remote decoder. The display of the repeated picture, however, is in accordance with the normal display of a non-progressive picture, i.e, the fields that make up the non-progressive picture are alternately displayed.

If a moving object appears in the pictures recorded under the interlaced scanning format, each field will display the moving object in one specific position. Thus, as these fields are alternately displayed during the freeze trick mode, the moving object in the display rapidly moves from one position in the display to another; in effect, the moving object appears to vibrate. This vibration is created because the interlaced fields are temporally distinct, and the moving object appears in a different position for each field.

This problem is also present in DTVs that include a deinterlacer. As is known in the art, a deinterlacer can construct complete frames from an interlaced field. Thus, a deinterlacer can construct complete frames out of the fields that comprise the repeated non-progressive frame. Nevertheless, these complete frames constructed from the interlaced fields will also be displayed in an alternate fashion thereby creating the possibility of the vibration artifact. In addition, this vibration effect appears in not only a freeze trick mode but may also be present in any other trick mode in which non-progressive pictures are repeated. Thus, it is desirable to eliminate the bit rate problem and the vibration artifact without increasing system costs or complexity.

### SUMMARY OF THE INVENTION

The present invention concerns a method of performing a trick mode on a video signal containing a plurality of original pictures. The invention includes the steps of receiving a trick mode command and selectively inserting at least one dummy predictive picture in the video signal using at least one prediction scheme among field-based prediction and frame-based prediction. The selectively inserting step converts the video signal to a trick mode video signal. In one arrangement, the selectively inserting step can include the step of selectively inserting at least a first dummy predictive picture in the video signal using field-based prediction and subsequent dummy predictive pictures in the trick mode video signal using frame-based prediction.

In another arrangement, the method can also include the step of predicting the at least first dummy predictive picture from a single field associated with a reference picture. This reference picture can be an intra picture or a predictive picture. Additionally, the reference picture can be a non-progressive picture, a progressive picture or a field picture.

In one aspect of the invention, the plurality of original pictures can be contained within a group of pictures, and the reference picture that is used to predict the at least first dummy predictive picture can be the last original picture in the group of pictures such that no other original pictures are predicted from the inserted dummy predictive pictures. In another aspect, the plurality of original pictures can be in a group of pictures, and the method can further include the step of, following the selectively inserting step, skipping any remaining original pictures that follow a final inserted dummy predictive picture such that the last picture in the group of pictures is the final inserted dummy predictive picture. In another aspect, the plurality of original pictures can be in an original group of pictures not containing dummy predictive pictures or repeated original pictures, and the method can further include the step of, following the selectively inserting step, retransmitting the original GOP for decoding.

Also, the trick mode command can be a freeze or a slow motion trick mode command, and the method can further include the step of decoding at least a portion of the trick mode video signal with a remote decoder. The dummy predictive picture can also be a non-progressive predictive picture.

The present invention concerns another method of performing a trick mode on a video signal containing a plurality of original pictures. This method includes the steps of receiving a trick mode command, in response to the trick mode command, selectively repeating at least one of the original pictures in which the selectively repeating step converts the video signal to a trick mode video signal and selectively inserting at least one dummy predictive picture in the trick mode video signal using at least one prediction scheme among field-based prediction or frame-based prediction. This method can also include the step of monitoring the trick mode video signal in which the selectively inserting step can be done if a bit rate of the trick mode video signal exceeds a predetermined threshold.

In one arrangement, each of the plurality of original pictures can contain a display indicator, and the method can further include the step of selectively modifying the display indicator of at least a portion of the plurality of original pictures to reflect an intended display order when an original picture is repeated or when a dummy predictive picture is inserted in the trick mode video signal. The display indicator can be a temporal reference field. Each temporal reference field can have an integer value, and the step of selectively modifying the temporal reference field of at least a portion of the plurality of original pictures can include the step of incrementally increasing by one the integer value of the temporal reference field each time an original picture is repeated or when a dummy predictive picture is inserted in the trick mode video signal. In this method, the dummy predictive picture can be a non-progressive dummy predictive picture.

The present invention also concerns a system for performing a trick mode on a video signal containing a plurality of original pictures. The system includes a controller for reading data from a storage medium and outputting the video signal containing the plurality of original pictures and a processor. The processor is programmed to receive a trick mode command and selectively insert at least one dummy predictive picture in the trick mode video signal using field-based prediction or frame-based prediction. The selectively inserting step converts the video signal to a trick mode video signal. The system also includes suitable software and circuitry to implement the methods as described above.

### BRIEF DESCRIPTION OF THE DRAWINGS

FIG. 1 is a block diagram of a system that can perform trick modes using dummy predictive picture in accordance with the inventive arrangements herein.

FIG. 2 is a flow chart that illustrates an operation for performing trick modes using dummy predictive pictures in accordance with the inventive arrangements.

FIG. 3A illustrates a typical group of pictures having non-progressive pictures in accordance with the inventive arrangements.

FIG. 3B illustrates a portion of a group of pictures including inserted dummy predictive pictures and an example of a prediction scheme in accordance with the inventive arrangements.

FIG. 3C illustrates a portion of a group of pictures including inserted dummy predictive pictures and an example of another prediction scheme in accordance with the inventive arrangements.

FIG. 3D illustrates a portion of a group of pictures containing non-progressive pictures in which a display indicator of the pictures has been modified in accordance with the inventive arrangements.

FIG. 4 is another flow chart that illustrates another method for performing a trick mode using dummy predictive pictures in accordance with the inventive arrangements.

FIG. 5 is yet another flow chart that illustrates another operation for performing a trick mode using dummy predictive pictures in accordance with the inventive arrangements.

FIG. 6 illustrates a portion of a group of pictures including inserted dummy predictive pictures and an example of another prediction scheme in accordance with the inventive arrangements.

### DETAILED DESCRIPTION OF THE PREFERRED EMBODIMENTS

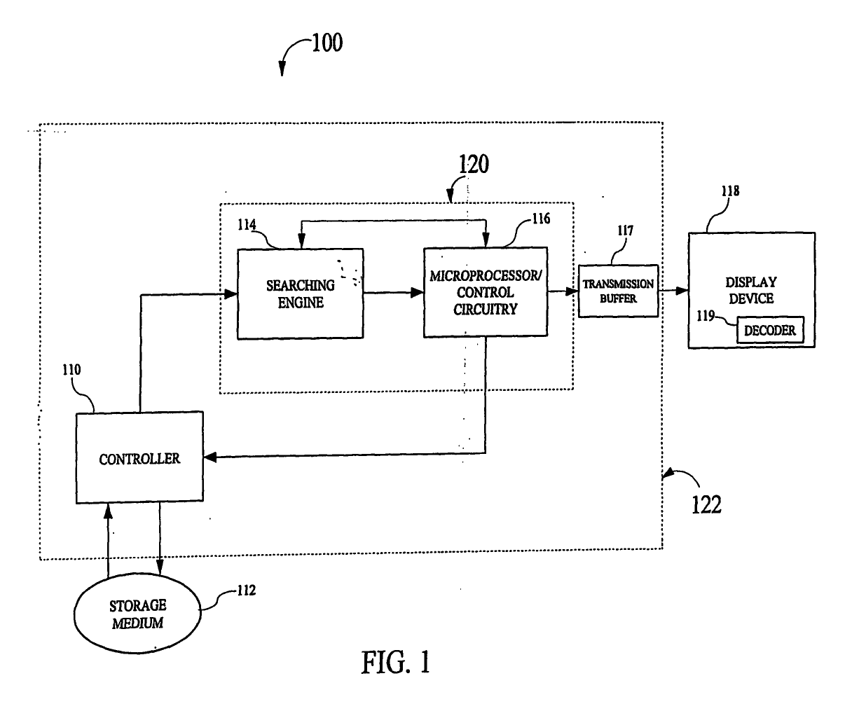

A system 100 for implementing the various advanced operating features in accordance with the inventive arrangements is shown in block diagram form in FIG. 1. The invention, however, is not limited to the particular system illustrated in FIG. 1, as the invention can be practiced with any other system capable of receiving a digitally encoded signal and transferring that signal to a display device. In addition, the system 100 is not limited to reading data from or writing data to any particular type of storage medium, as any storage medium capable of storing digitally encoded data can be used with the system 100.

The system 100 can include a controller 110 for reading data from and writing data to a storage medium 112. The system 100 can also have a searching engine 114, a microprocessor 116, a transmission buffer 117 and a display device 118. The searching engine 114 can contain suitable software and circuitry for locating one or more particular types of pictures in a video signal read from the storage medium 112. Control and data interfaces can also be provided for permitting the microprocessor 116 to control the operation of the controller 110 and the searching engine 114. Suitable software or firmware can be provided in memory for the conventional operations performed by the microprocessor 116. Further, program routines can be provided for the microprocessor 116 in accordance with the inventive arrangements.

It should be understood that all or portions of the searching engine 114 and the microprocessor 116 can be a processor 120 within contemplation of the present invention. Further, all or portions of the controller 1 10, the searching engine 1 14, the microprocessor 116 and the transmission buffer 1 17 can be a bitstream source 122 within contemplation of the present invention. In one arrangement, the display device 118 can contain its own decoder 1 19 for decoding all or a portion of any video signal read from the storage medium 112 and processed by the bitstream source 122. In this particular arrangement, a decoder (not shown) in the bitstream source 122 typically does not decode the video signal read from the storage medium 112. This particular embodiment can be referred to as a remote decoder arrangement. It should be noted, however, that the invention is not limited to this arrangement, as the invention can be practiced in other suitable systems.

In operation, the controller 110 can read a video signal containing a plurality of original pictures from the storage medium 112. These original pictures can be non-progressive pictures, progressive pictures or field pictures. In one arrangement, if the microprocessor 1 16 receives a trick mode command such as a slow motion or freeze command, the microprocessor 116 can selectively repeat at least one of the original pictures to convert the video signal to a trick mode video signal. Thus, the trick mode video signal can contain the original pictures as well as duplicates or repeats of one or more original pictures.

In addition, during the trick mode command, the microprocessor 116, can signal the searching engine 114 to locate one or more suitable original pictures in the trick mode video signal. Once a suitable original picture is located, the searching engine 114 can signal the microprocessor 116, and the microprocessor 116 can generate a corresponding dummy predictive (P) picture. A dummy P picture is a P picture that can be predicted from certain pictures in which the dummy P picture's motion vectors are set to zero and its residual signal is set to zero or not encoded. For purposes of the invention, the dummy P picture can be a non-progressive dummy P picture; however, the invention is not so limited, as the dummy P picture can be any other suitable picture type such as a progressive or field picture.

The microprocessor 116 can then selectively insert at least one of the corresponding dummy P pictures such that the dummy P picture, instead of a repeated original picture, is sent to the transmission buffer 1 17 and on to the display device 118 and decoder 119. Inserting dummy P pictures in the trick mode video signal can cause the overall bit rate of the signal to decrease, as dummy P pictures contain relatively small amounts of encoded data.

Generating dummy P pictures in this manner, i.e., when the microprocessor 116 receives a trick mode command, is referred to as generating dummy P pictures “on-the-fly.” Alternatively, the microprocessor 116 can generate dummy P pictures prior to the initiation of a trick mode command in which one or more of the dummy P pictures can be stored in memory (not shown). Once the microprocessor 116 receives a trick mode command, the microprocessor 116 can retrieve one or more of the dummy P pictures from memory and insert them into the trick mode video signal. In either arrangement, the dummy P pictures can take the place of one or more of the repeated original pictures such that the dummy P picture is transmitted to the display device 11,8 and displayed instead of a repeated original picture.

In another aspect of the invention, once the microprocessor 116 receives a trick mode command, the microprocessor 116 can monitor the bit rate of the trick mode video signal. If the bit rate of the trick mode video signal exceeds a predetermined threshold, then the microprocessor 116, in conjunction with the searching engine 114, can perform the selectively inserting step discussed above in which at least one dummy P picture can be inserted in the trick mode video signal.

In one particular embodiment of the invention, the microprocessor 116 can merely insert dummy P pictures into the video signal read from the storage medium 112 to form a trick mode video signal. As an example, if a freeze or pause trick mode command is received, during the duration of the command, the microprocessor 116 can insert into the video signal dummy P pictures in which the first dummy P picture can be predicted from the original picture on which the freeze trick mode was initiated. It is understood, however, that this process is not limited to a freeze trick mode, as this particular embodiment can be practiced with slow motion trick modes as well.

To avoid a vibrating pictures problem, upon the initiation of a trick mode command such as a freeze trick mode, the searching engine 114 can locate a particular original picture. In one arrangement, this original picture can be the last picture in a group of pictures (GOP). The microprocessor 116 can insert one or more non-progressive dummy P pictures in the video signal containing the original pictures in which the first dummy P picture is predicted from a single field of the last original picture. If the original picture on which the freeze trick mode is initiated is not the last original picture in the GOP, the microprocessor 116 can delay the commencement of the trick mode such that the first dummy predictive picture is predicted from the last original picture in the GOP.

Alternatively, the searching engine 114 can locate an original picture that is not the last picture in a GOP, and the microprocessor 116 can skip or delete any original pictures that follow the last dummy P picture to be inserted in the video signal (in this alternative embodiment, the first dummy P picture can be predicted from a single field of the original picture from which it is predicted as well). As will be explained below, this single field prediction scheme can help eliminate the vibrating pictures artifact. Also, ensuring that the last picture in the GOP is a final inserted dummy predictive picture such that no other pictures are predicted from the dummy predictive pictures can maintain the quality of the display of the video signal.

In another arrangement, the microprocessor 116 can modify certain portions of information contained within one or more of the plurality of original pictures contained in the trick mode video signal to reflect an intended display order. This modification step can be performed whether original pictures are repeated or dummy P pictures are inserted in the video signal. The overall operation of the invention will be discussed in greater detail below.

### Trick Modes Using Non-Progressive Dummy Predictive Pictures

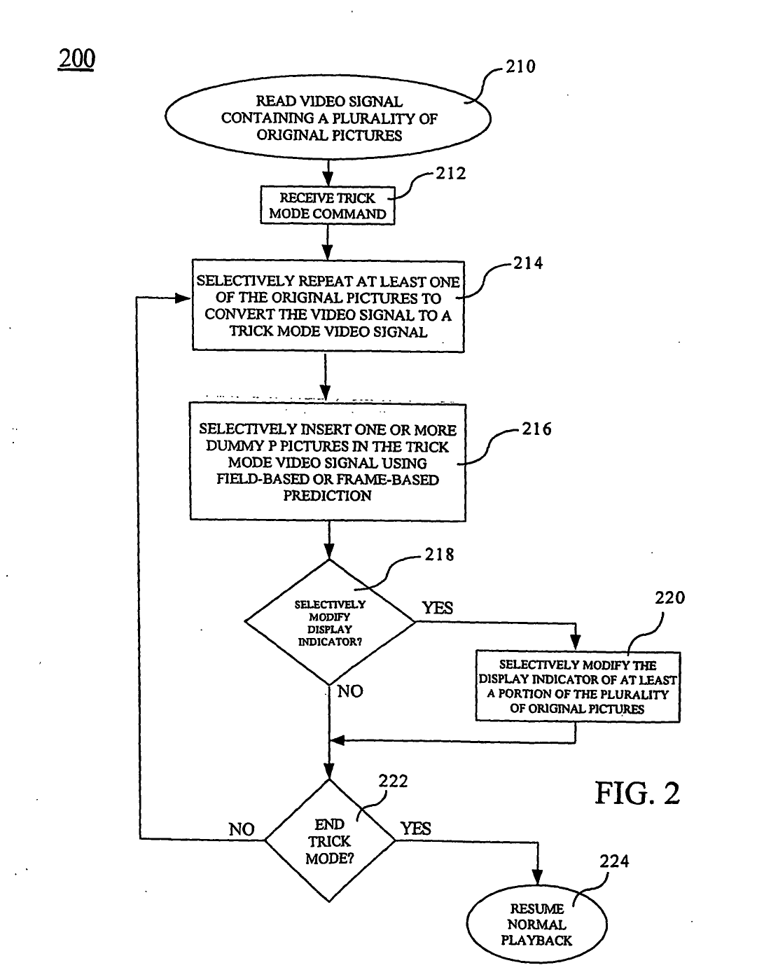

Referring to FIG. 2, a method 200 that demonstrates one way in which trick modes using dummy P pictures can be performed is illustrated. In one embodiment, the invention can be practiced in a remote decoder arrangement. For purposes of the invention, a remote decoder arrangement can be any system in which at least a portion of the pictures in a video signal can be decoded by a decoder that is external to and not under the control of a bitstream source that is providing the pictures to the decoder.

As an example, the bitstream source can be an optical storage medium player or recorder that reads multimedia data from an optical storage medium and transfers this data over a transmission channel to a digital television, which contains its own decoder. It is understood, however, that the invention is not limited to this example or even a remote decoder arrangement, as the invention can be practiced in any other suitable system or arrangement.

At step 210, a video signal containing a plurality of original pictures can be read. In one arrangement, these original pictures can be non-progressive pictures, progressive pictures or field pictures. At step 212, a trick mode command can be received. For purposes of the invention, the trick mode command can be any command in which one or more of the original pictures would normally be repeated, including a pause or freeze command or a slow motion command.

In response to the trick Mode command, at step 214, at least one of the original pictures can be repeated to convert the video signal into a trick mode video signal. Although not meant to limit the scope of the invention in any way, this method 200 will demonstrate the repeating of original B pictures in a GOP to form a trick mode video signal and the insertion of dummy P pictures into that trick mode video signal in which the dummy P pictures are predicted from original I and P pictures contained in the GOP.

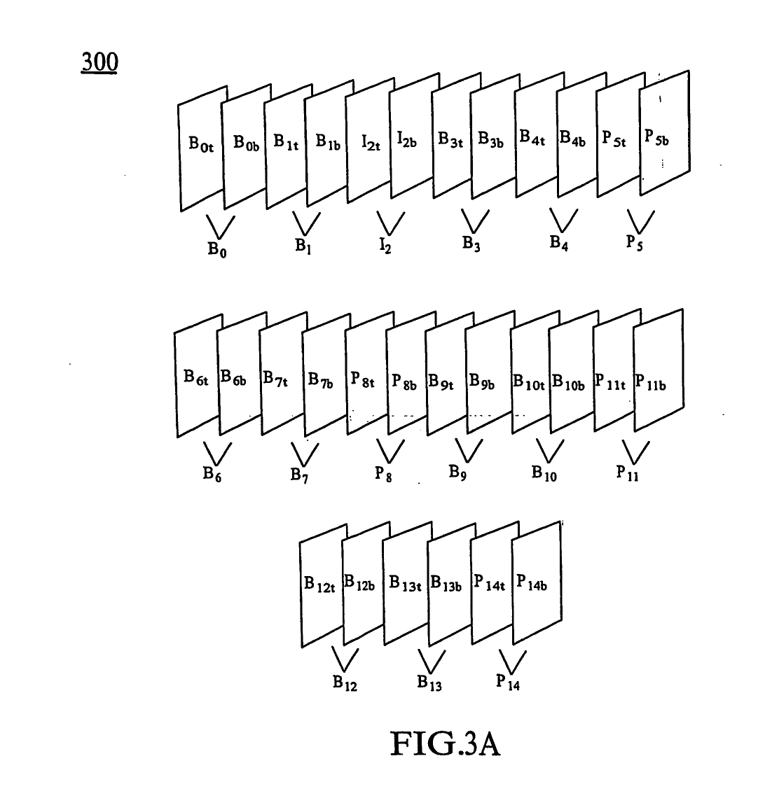

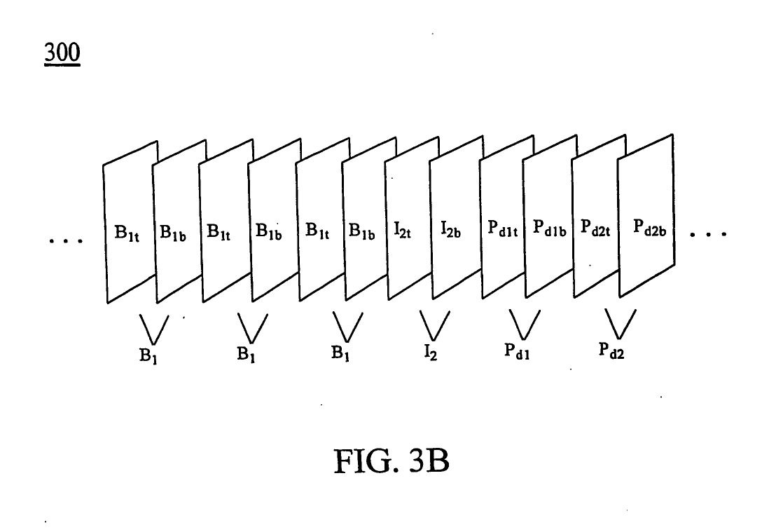

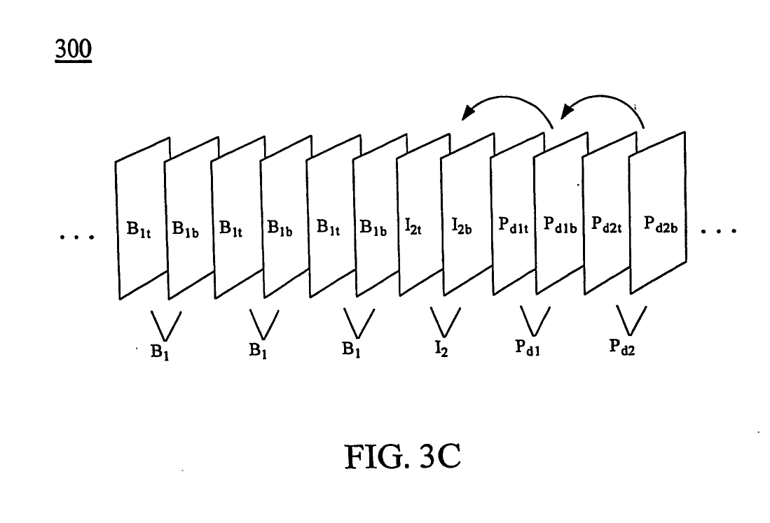

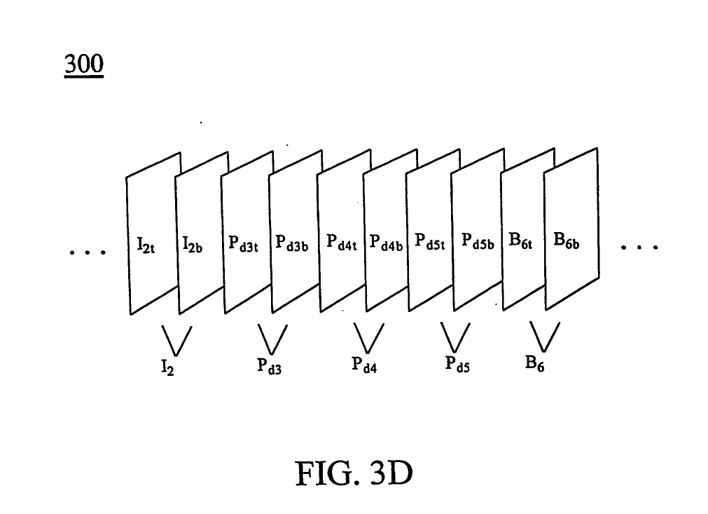

Referring to FIG. 3A, a GOP 300 containing non-progressive pictures in display order is shown. The subscript numbers indicate when each picture will be displayed—relative to the other pictures in the GOP—at a normal playback speed. The lowercase letter “t” can represent a top field, and the lowercase letter “b” can represent a bottom field. This GOP 300 can be one of many GOPs in a video signal. Although the invention is not limited to this particular GOP structure, the GOP 300 will serve to illustrate how a slow motion trick mode using non-progressive dummy P pictures can be performed.

Referring back to FIG. 2, at step 216, one or more dummy P pictures can be selectively inserted in the trick mode video signal using field-based or frame-based prediction. These dummy P pictures can be non-progressive, progressive or field pictures. As previously noted, a dummy P picture is a P picture that can be predicted from certain pictures in which the dummy P picture's motion vectors are set to zero and its residual signal is set to zero or not encoded. For example, in MPEG signals, a dummy P picture's discrete cosine transform (DCT) coefficients can be set to zero or not encoded. As such, a dummy P picture contains very little information. A dummy P picture's primary purpose is to duplicate or repeat the picture, or a field of the picture, from which it was predicted using very few bits. Thus, a dummy P picture is suitable for replacing one or more repeated original pictures in a trick mode video signal, and a trick mode video signal can contain repeated original pictures and/or dummy P pictures.

These dummy P pictures can be transmitted to a remote decoder instead of repeated original pictures. This process can maintain a bit rate of a trick mode video signal at a manageable level, as the bit rate of such signals tends to be elevated because many of these original pictures, including those encoded with a large number of bits, would normally be repeated during the trick mode command. Examples of several prediction schemes using dummy P pictures will be described below.

For example, referring back to FIG. 3A, if a slow motion trick mode command having a playback speed of ⅓× (1× represents normal playback speed) is to be performed, each of the B pictures in the GOP 300 can be repeated twice. Repeating the B pictures should not lead to the bit rate of the trick mode video signal being too high, as B pictures contain relatively low amounts of bits, at least with respect to I and P pictures. Two dummy P pictures can be inserted after (in display order) each of the original pictures that are reference pictures. For purposes of the invention, a reference picture can be any picture from which other pictures can be predicted, such as an I or P picture. These reference pictures can also be non-progressive pictures, progressive pictures or even field pictures.

A partial example of the procedure discussed above is illustrated in FIG. 3B, where two dummy predictive pictures are shown inserted after picture I₂. Here, the first field, P_{d1t}, of the first dummy P picture, P_{d1}, can be predicted from the first field, I₂ₜ, of picture I₂ (where “d” indicates that the picture is a dummy picture and the number following “d,” in this case, the number “1,” represents the display order of the dummy P picture with respect to any other dummy P picture).

In addition, the second field, P_{d1b}, of the first dummy P picture, P_{d1}, can be predicted from the second field, I_{2b}, of picture I₂. Alternatively, the fields of the first dummy P picture can be predicted from the fields of picture I₂ having the opposite parity. The fields, P_{d2t} and P_{d2b}, of the following dummy P picture, P_{d2}, can be predicted from the fields P_{d1t} and P_{d1b} in accordance with either of these examples, and either process can be repeated for predicting subsequent dummy P pictures. The same parity field-based prediction with respect to the second dummy P picture, P_{d2}, is shown in FIG. 3B. Both of the arrangements discussed above represent examples of field-based prediction schemes.

Referring to FIG. 3C, an alternative to field-based prediction is shown. As an example, the fields, P_{d1t} and P_{d1b}, of the first dummy P picture, P_{d1}, can be predicted from picture I₂ using frame-based prediction. Moreover, each of the subsequent dummy P pictures can be predicted from the previous dummy P picture using frame-based prediction. In another arrangement, a portion of the dummy P pictures can be predicted using field-based prediction, and another portion can be predicted using frame-based prediction.

It must be noted that the invention is not limited with respect to the discussion relating to steps 214 and 216, as other procedures can be used to create a trick mode video signal and other prediction schemes are available. For example, it is unnecessary to repeat any original pictures to create a trick mode video signal, as merely inserting dummy P pictures predicted from the reference pictures in a GOP will do so. In this example, enough dummy P pictures can be inserted to achieve the desired playback speed (this can compensate for the lack of repeated original pictures).

Referring back to FIG. 2, in another embodiment, each of the plurality of original pictures can contain a display indicator. As determined at decision block 218, if the display indicators of these pictures are to be selectively modified, then the display indicator of at least a portion of the plurality of original pictures can be selectively modified following the repeating of original pictures or the insertion of dummy P pictures, as shown at step 220.

Notably, modifying these display indicators can reflect an intended display order of the plurality of original pictures when an original picture is repeated or a dummy P picture is inserted in the trick mode video signal. It is understood, however, that this process can be performed irrespective of whether dummy P pictures are inserted during the trick mode. Thus, the step of modifying a display indicator can be performed during a conventional trick mode in which pictures are merely repeated and no dummy P pictures are inserted into the video signal. Referring back to the method 200, if the display indicators are not to be modified, the method 200 can continue at decision block 222.

In one arrangement, the display indicator can be a temporal reference field. A temporal reference field is typically a ten bit field located in the picture header of digitally encoded pictures. Some decoders rely on the temporal reference field to determine when a particular picture in a video signal will be displayed relative to other pictures in the video signal. This field normally has an integer value.

As an example, referring once again to FIG. 3A, GOP 300 contains fifteen pictures. The subscript numbers for the pictures in the GOP 300 can correspond to the integer values for each respective picture's temporal reference field. For instance, the temporal reference field of picture B₀, the first picture in the GOP 300, can have an integer value of zero. The temporal reference field of picture B₁, the next picture to be displayed, can have an integer value of one. Thus, the integer value of the temporal reference field for each subsequent picture to be displayed can be higher by one, all the way to picture P₁₄, whose temporal reference field can have an integer value of fourteen. For convenience, the phrase “integer value of the temporal reference field” can also be referred to as “integer value.”

When an original picture is repeated or when a dummy P picture is inserted in the trick mode video signal, the display order according to the temporal reference fields of the original pictures is no longer valid. Accordingly, the integer value of the temporal reference fields of the original pictures that follow the inserted dummy P pictures can be modified to indicate a proper display order.

For example, if the picture I₂ in the GOP 300, is sent to the display device and three corresponding dummy P pictures are sent as well (this is in accordance with a ¼× slow motion playback), the integer value of the temporal reference field of the picture I₂ (assuming that it is the third picture in the GOP to be displayed) can be kept as two, the temporal reference field of the first dummy P picture can be set to an integer value of three, the temporal reference field of the second dummy P picture can be set to an integer value of four and the temporal reference field of the third dummy P picture can be set to an integer value of five. In addition, the temporal reference field of the next original picture to be displayed, picture B₃, can be modified from its original integer value of three to an integer value of six (B₆). The final result of this example is illustrated in FIG. 3D.

This step of incrementally increasing the integer values of the temporal reference fields of the original pictures can continue until the trick mode is rescinded and the temporal reference field of the last picture in the last trick mode GOP (the last GOP affected by the trick mode) is modified. Once the next GOP is reached, the integer value of the temporal reference field of the first display picture in the new GOP can be zero. Thus, each time a dummy P picture is inserted into the trick mode video signal, the integer value of the temporal reference fields of each original picture following the inserted dummy P pictures can be incrementally increased by one through the trick mode GOPs to reflect the intended display order.

The integer value for the temporal reference field can have a maximum value of 1,023. If the integer values for the temporal reference fields of the pictures that make up a trick mode GOP (the original pictures plus the dummy P pictures) reach this value, then the temporal reference field can merely wrap around and begin again at zero. As an example, if a freeze trick mode is initiated, the integer value of one of the dummy P pictures or one of the original pictures may eventually reach 1,023. Once that occurs, the integer value for the temporal reference field of the next immediate dummy P or original picture to be displayed can be set to zero.

Of course, it should be noted that the invention is not limited to the use of a temporal reference field, as any other suitable display indicator can be modified to reflect an intended display order in either of the embodiments discussed above. Also, the wrap around value is by no means limited to 1,023, as other suitable values can be used. Referring back to FIG. 2, at decision block 222, it can be determined whether the trick mode is to continue. If so, the method 200 can continue at step 214. If not, normal playback can resume at step 224.

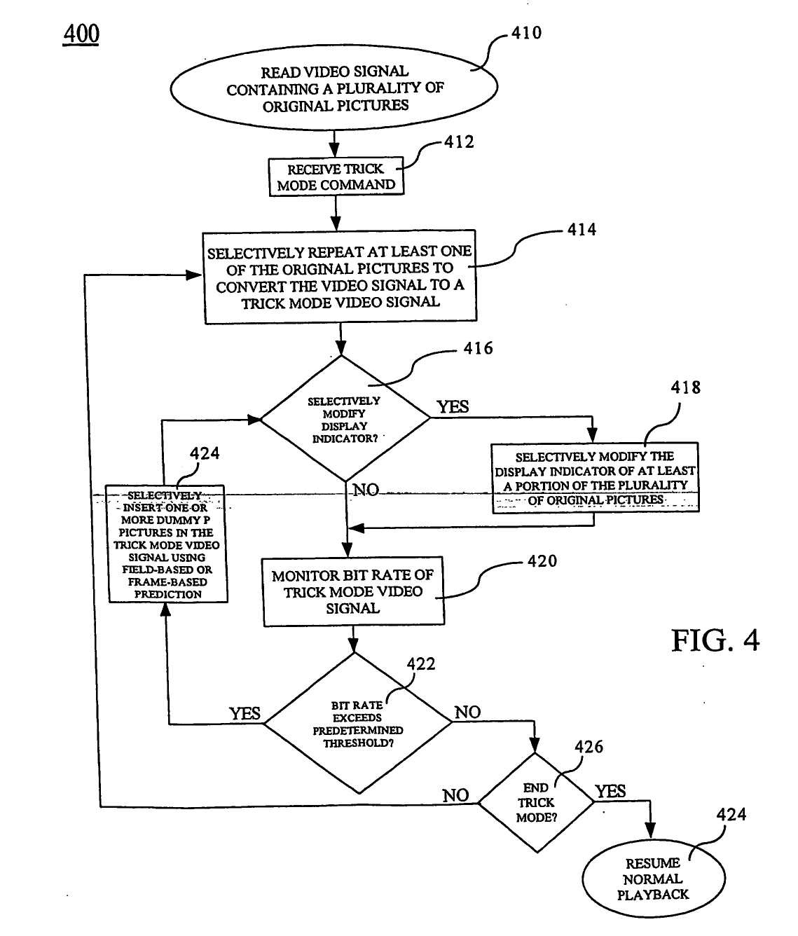

Turning to FIG. 4, a method 400 illustrates another way of using dummy P pictures during a trick mode. At step 410, a video signal containing a plurality of original pictures can be read. Similar to method 200, these original pictures can be non-progressive pictures, progressive pictures or field pictures. This method 400 can be practiced in a remote decoder arrangement but is not so limited. At step 412, a trick mode command such as a freeze trick mode command or a slow motion trick mode command can be received. At step 414, at least one of the original pictures can be selectively repeated to convert the video signal to a trick mode video signal. At steps 416 and 418, if desired, the display indicators of at least a portion of the original pictures can be modified in accordance with the discussion relating to steps 218 and 220 of method 200.

During the trick mode command, the bit rate of the trick mode video signal can be monitored, as shown at step 420. Monitoring the bit rate may be necessary during a trick mode because several original pictures in the video signal may be repeated one or more times thereby resulting in an increased bit rate. In certain cases, this increased bit rate may exceed the maximum allowable bit rate for the transmission channel that is carrying the trick mode video signal. For purposes of the invention, this maximum allowable bit rate for the transmission channel can be referred to as a predetermined threshold.

At decision block 422, it can be determined whether the bit rate of the trick mode video signal has exceeded this predetermined threshold. If the bit rate has not reached the predetermined threshold and the trick mode is to go on at decision block 426, then the method 400 can continue at decision block 414. Referring back to decision block 422, if the bit rate has exceeded the predetermined threshold, then one or more dummy P pictures can be inserted in the trick mode video signal using field-based prediction or frame-based prediction, as shown at step 424. Again, these dummy P pictures can be non-progressive, progressive or field pictures.

This insertion step can be in accordance with the discussion relating to step 216 of method 200. Also, it is unnecessary to replace the duplicates or repeats of an original picture if the original picture is a B picture. Following step 424, the method 400 can continue at decision block 416, where the display indicators of the original pictures that follow the dummy P pictures can be modified if so desired. If the trick mode is to stop as determined at decision block 426, then normal playback can resume, as shown at step 428. It is understood, however, that the trick mode can be rescinded at any other suitable step in the method 400.

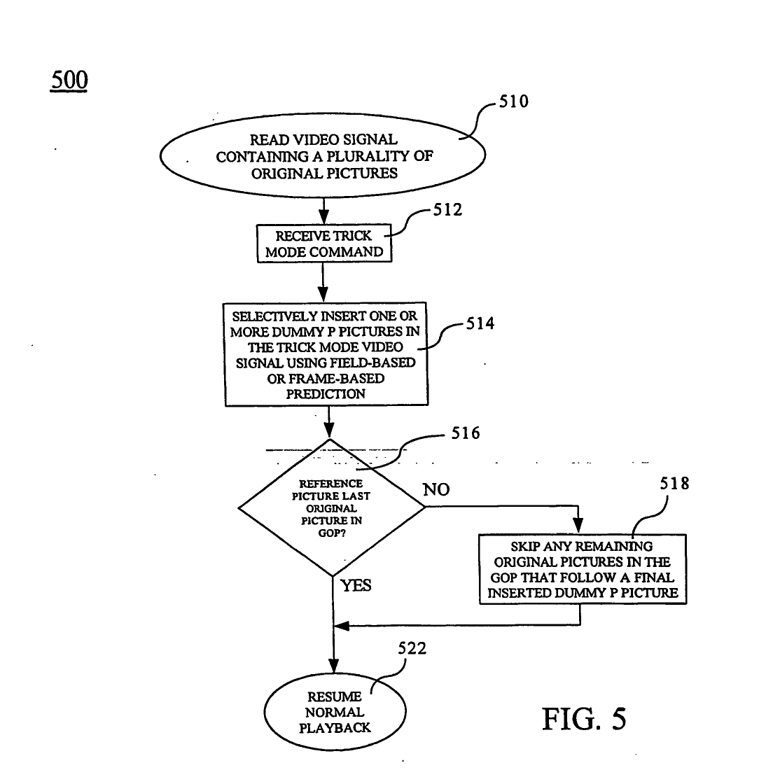

Referring to FIG. 5, a method 500 for helping eliminate a vibrating pictures artifact when dummy P pictures are inserted into a video signal is shown. Like method 200 and 400, method 500 can be employed in a remote decoder arrangement, but the method 500 can also be practiced with other suitable systems. At step 510, a video signal containing a plurality of original pictures can be read, and at step 512, a trick mode command can be received. As an example, the trick mode command can be a freeze trick mode command. At step 514, one or more dummy P pictures can be inserted in the video signal in which the dummy P pictures are predicted using either field-based or frame-based prediction. These dummy P pictures can be non-progressive, progressive or field pictures. Inserting these dummy P pictures can convert the video signal to a trick mode video signal.

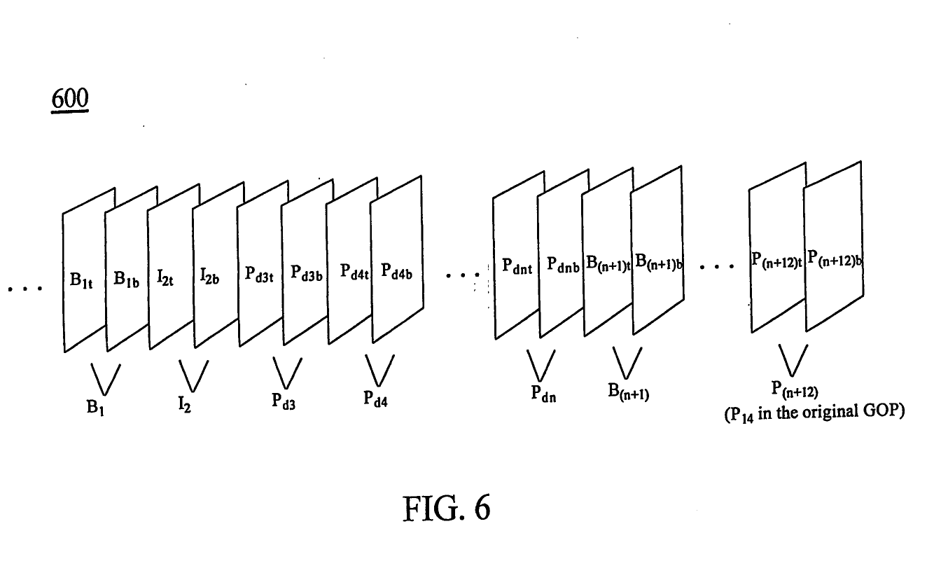

In one arrangement, the first dummy P picture inserted in the video signal can be predicted from a reference picture using field-based prediction and subsequent dummy P pictures can be predicted using frame-based prediction. In particular, the first dummy P picture can be predicted from a single field associated with the reference picture. This particular prediction scheme, as will be explained below, can help control vibration artifacts. Referring to FIG. 6, an example of such as process is illustrated.

In FIG. 6, a portion of a freeze trick mode GOP 600 containing several non-progressive pictures and dummy P pictures in display order is shown. The subscript numbers on the pictures in the GOP 600 reflect an intended display order of the pictures. If a freeze trick mode command is received, for example, then the freeze can be performed on a reference picture, such as I₂, where I₂ can include the fields I₂ₜ and I_{2b}. Of course, the trick mode can be performed on any other suitable reference picture in a GOP, including any P pictures. The reference picture can be either a non-progressive, progressive or field picture.

If the dummy P pictures are frame pictures, i.e. the dummy P pictures contain at least two fields, the fields that make up the first dummy P frame picture can be predicted from a single field of the reference picture, in this case picture I₂. Thus, as shown in FIG. 6, the fields—P_{d3t} and P_{d3b}—of the first dummy P frame picture P_{3d} can be predicted from a single field of the picture I₂, such as the bottom field I_{2b}. In another arrangement, the fields P_{d3t} and P_{d3b} can be predicted from the top field I₂ₜ.

The subsequent dummy P pictures, from picture P_{d4} to picture P_{dn} (where n represents the display order number given to the final inserted dummy P picture), can be predicted using frame-based prediction. That is, each successive dummy P frame picture, following the first dummy P frame picture, can be predicted from the previous dummy P frame picture using frame-based prediction. For example, following the field-based prediction of the first dummy P frame picture, the fields, P_{d4t} and P_{d4b}, of the second dummy P frame picture, P_{d4}, can be predicted from the first dummy P frame picture using frame-based prediction.

It is understood, however, that subsequent dummy P pictures can be predicted from previous dummy P picture using field-based prediction as well. This field-based prediction includes single field-based prediction—like the process described in relation to the first dummy P picture—and the field-based prediction scheme illustrated in connection with FIG. 3B. Nonetheless, because the first dummy P frame picture was predicted using single field prediction, the fields of the second dummy P frame picture, as well as any subsequent dummy P pictures, can be duplicates of the field from which the first dummy P frame picture was predicted.

Although the invention is in no way limited to this particular prediction scheme, this single field-based prediction can help control the vibrating pictures artifact in addition to keeping a bit rate of a trick mode video signal at an acceptable level.

Specifically, predicting the fields of the first dummy P frame picture from a single field of the reference picture if dummy P frame pictures are used during a trick mode can produce a display in which a moving object appears in one specific position for each of the fields of the dummy P frame pictures to be displayed.

That is, if a moving object appears in the reference picture from which the first dummy P frame picture is predicted and the fields of the first dummy P frame picture are predicted from a single field of this reference picture, then each field of subsequent dummy P frame pictures will include the moving object in the same position as it is located in the single reference field. Accordingly, as the dummy P frame pictures are displayed during the trick mode, the moving object does not appear to vibrate.

Referring back to method 500 of FIG. 5, at decision block 516, it can be determined whether the reference picture from which the first dummy P picture is predicted is the last original picture in a GOP. If it is, the method 500 can end at step 522. Referring back to FIG. 6, picture P₁₄ is an example of a last original picture in a GOP. Turning once again to FIG. 5, if the reference picture is not the last original picture in the GOP, then any remaining original pictures in the GOP that follow a final inserted dummy P picture can be skipped, as shown at step 518.

Because the first dummy P picture may be predicted from a single field of the reference picture, the first dummy P picture and each of the subsequent dummy P pictures will be predicted from an incomplete original picture. If any original pictures are predicted from the final inserted dummy P picture, the original picture may be of poor display quality. By not predicting any original pictures from the final inserted dummy P picture, however, the quality of the display of the video signal, once normal playback resumes, will not suffer from the effects of single field-based prediction.

As an example, as shown in FIG. 6, any original pictures that follow the final inserted dummy P picture, P_{dn}, can be skipped. In this example, original pictures B₃ (now labeled as picture B₍ₙ₊₁₎) through P₁₄ (now labeled as P₍ₙ₊₁₂₎) can be skipped, and normal playback of the video signal can resume at the next GOP. The skipping process would not be required if the freeze trick mode were initiated on the last original picture in the GOP 600, which normally would be picture P₁₄ (now labeled as picture P₍ₙ₊₁₂₎) in the original GOP (an example of which is reproduced in FIG. 3).

As an alternative to step 518, if the trick mode was to be initiated on a reference picture that was not the last original picture in a GOP, the initiation of the trick mode can be delayed such that it is commenced on the last original picture in the GOP. For example, if a freeze trick mode was originally intended to begin at reference picture I₂ of GOP 600 in FIG. 6, the start of the trick mode can be delayed such that it will start at picture P₁₄ (or P₍ₙ₊₁₂₎), the last original picture in the GOP 600.

In yet another alternative arrangement to step 518 (where the trick mode was initiated on a reference picture that was not the last original picture in the original GOP), once the trick mode is stopped and normal playback is to resume, an original GOP can be retransmitted for decoding and display at normal playback speed. The term “original GOP” can mean a GOP containing original pictures but no dummy P pictures, repeated original pictures or skipped original pictures.

Referring back to FIG. 3A, GOP 300 can be an original GOP. Consider the following example: assume a freeze trick mode was initiated on reference picture P₈ of GOP 300 and single field-based prediction was used to predict the first inserted dummy P picture. In view of the single-field prediction and as explained earlier, any original pictures that follow (in display order) the last inserted dummy P picture may encounter prediction problems.

In accordance with the inventive arrangements, once the freeze trick mode is stopped, the GOP 300 (the original GOP) can be retransmitted to a decoder for decoding and eventual display. That is, following the end of the freeze trick mode, each of the original pictures (but not the inserted dummy P pictures) in GOP 300 can be retransmitted, decoded and displayed. The invention is not limited to this particular example, as other suitable trick modes can be employed and the trick mode can be initiated on any other suitable reference picture in GOP 300. Referring back to FIG. 5, the method 500 can end at step 522.

Although the present invention has been described in conjunction with the embodiments disclosed herein, it should be understood that the foregoing description is intended to illustrate and not limit the scope of the invention as defined by the claims.

1. A method of performing a trick mode on a video signal containing a plurality of original pictures, comprising the steps of:
receiving a trick mode command; and
selectively inserting at least one dummy predictive picture in the video signal using at least one prediction scheme among field-based prediction and frame-based prediction, wherein said selectively inserting step converts the video signal to a trick mode video signal.

2. The method according to claim 1, wherein said selectively inserting step comprises the step of selectively inserting at least a first dummy predictive picture in the video signal using field-based prediction and subsequent dummy predictive pictures in the trick mode video signal using frame-based prediction.

3. The method according to claim 2, further comprising the step of predicting the at least first dummy predictive picture from a single field associated with a reference picture.

4. The method according to claim 3, wherein the reference picture is a picture selected from the group comprising an intra picture and a predictive picture.

5. The method according to claim 3, wherein the reference picture is a picture selected from the group comprising a non-progressive picture, a progressive picture and a field picture.

6. The method according to claim 3, wherein the plurality of original pictures is contained within a group of pictures and wherein the reference picture that is used to predict the at least first dummy predictive picture is the last original picture in the group of pictures such that no other original pictures are predicted from the inserted dummy predictive pictures.

7. The method according to claim 6, further comprising the step of delaying said selectively inserting step to permit the first dummy predictive picture to be predicted from the reference picture that is the last original picture in the group of pictures.

8. The method according to claim 1, wherein the trick mode command comprises a freeze trick mode command.

9. The method according to claim 1, wherein the trick mode command comprises a slow motion trick mode command.

10. The method according to claim 1, further comprising the step of decoding at least a portion of the trick mode video signal with a remote decoder.

11. The method according to claim 1, wherein the plurality of original pictures is in a group of pictures and the method further comprises the step of, following said selectively inserting step, skipping any remaining original pictures that follow a final inserted dummy predictive picture such that the last picture in the group of pictures is the final inserted dummy predictive picture.

12. The method according to claim 1, wherein the dummy predictive picture comprises a non-progressive dummy predictive picture.

13. The method according to claim 1, wherein the plurality of original pictures is in an original group of pictures not containing dummy predictive pictures or repeated original pictures and the method further comprises the step of, following said selectively inserting step, retransmitting the original GOP for decoding.

14. A method of performing a trick mode on a video signal containing a plurality of original pictures, comprising the steps of:
receiving a trick mode command;
in response to the trick mode command, selectively repeating at least one of the original pictures, wherein said selectively repeating step converts the video signal to a trick mode video signal; and
selectively inserting at least one dummy predictive picture in the trick mode video signal using at least one prediction scheme among field-based prediction and frame-based prediction.

15. The method according to claim 14, further comprising the step of: monitoring the trick mode video signal, wherein said selectively inserting step is done if a bit rate of the trick mode video signal exceeds a predetermined threshold.

16. The method according to claim 14, wherein each of the plurality of original pictures contains a display indicator and the method further comprises the step of selectively modifying the display indicator of at least a portion of the plurality of original pictures to reflect an intended display order when an original picture is repeated or when a dummy predictive picture is inserted in the trick mode video signal.

17. The method according to claim 16, wherein the display indicator is a temporal reference field.

18. The method according to claim 17, wherein each temporal reference field has an integer value and the step of selectively modifying the temporal reference field of at least a portion of the plurality of original pictures comprises the step of incrementally increasing by one the integer value of the temporal reference field each time an original picture is repeated or when a dummy predictive picture is inserted in the trick mode video signal.

19. The method according to claim 14, wherein the dummy predictive picture is a non-progressive dummy predictive picture.

20. A system for performing a trick mode on a video signal containing a plurality of original pictures, comprising:
a controller for reading data from a storage medium and outputting the video signal containing the plurality of original pictures; and
a processor, wherein the processor is programmed to:
receive a trick mode command; and
selectively insert at least one dummy predictive picture in the trick mode video signal using at least one of a field-based prediction and frame-based prediction, wherein the selectively inserting step converts the video signal to a trick mode video signal.

21. The system according to claim 20, wherein the processor is further programmed to selectively insert at least a first dummy predictive picture in the trick mode video signal using field-based prediction and subsequent dummy predictive pictures in the trick mode video signal using frame-based prediction.

22. The system according to claim 21, wherein the processor is further programmed to predict the at least first dummy predictive picture from a single field associated with a reference picture.

23. The system according to claim 22, wherein the reference picture is a picture selected from the group comprising an intra picture and a predictive picture.

24. The system according to claim 22, wherein the reference picture is a picture selected from the group comprising a non-progressive picture, a progressive picture or a field picture.

25. The system according to claim 22, wherein the plurality of original picture is contained within a group of pictures and the reference picture that is used to predict the at least first dummy predictive picture is the last original picture in the group of pictures such that no other original pictures are predicted from the inserted dummy predictive pictures.

26. The system according to claim 25, wherein the processor is further programmed to delay the insertion of the dummy predictive pictures to permit the first dummy predictive picture to be predicted from the reference picture that is the last original picture in the group of pictures.

27. The system according to claim 20, wherein the trick mode command is a freeze trick mode command.

28. The system according to claim 20, wherein the trick mode command is a slow motion trick mode command.

29. The system according to claim 20, further comprising a remote decoder for decoding at least a portion of the trick mode video signal.

30. The system according to claim 20, wherein the plurality of original pictures is in a group of pictures and the processor is further programmed to, following the selectively insertion of the dummy predictive pictures, skip any remaining original pictures that follow a final inserted dummy predictive picture such that the last picture in the group of pictures is the final inserted dummy predictive picture.

31. The system according to claim 20, wherein the dummy predictive picture is a non-progressive dummy predictive picture.

32. The system according to claim 20, wherein the plurality of original pictures is in an original group of pictures not containing dummy predictive pictures or repeated original pictures and the processor is further programmed to, following the insertion of dummy predictive pictures, retransmit the original GOP for decoding.

33. A system for performing a trick mode on a video signal containing a plurality of original pictures, comprising:
a controller for reading data from a storage medium and outputting the video signal containing the plurality of original pictures; and
a processor, wherein the processor is programmed to:
receive a trick mode command;
in response to the trick mode command, selectively repeat at least one of the original pictures, wherein said selectively repeating step converts the video signal to a trick mode video signal; and
selectively insert at least one dummy predictive picture in the trick mode video signal using at least one prediction scheme among field-based prediction and frame-based prediction.

34. The system according to claim 33, wherein the processor is further programmed to monitor the trick mode video signal-and to selectively insert-the-dummy predictive pictures if a bit rate of the trick mode video signal exceeds a predetermined threshold.

35. The system according to claim 33, wherein each of the plurality of original pictures contains a display indicator and the processor is further programmed to selectively modify the display indicator of at least a portion of the plurality of original pictures to reflect an intended display order when an original picture is repeated or when a dummy predictive picture is inserted in the trick mode video signal.

36. The system according to claim 35, wherein the display indicator is a temporal reference field.

37. The system according to claim 36, wherein each temporal reference field has an integer value and the processor is further programmed to incrementally increase by one the integer value of the temporal reference field each time an original picture is repeated or when a dummy predictive picture is inserted in the trick mode video signal.

38. The system according to claim 33, wherein the dummy predictive picture is a non-progressive dummy predictive picture.
